(19) United States
(12) Patent Application Publication
(10) Pub. No.: US 2018/0172236 A1
(43) Pub. Date: Jun. 21, 2018

(54) LIGHT-GUIDED HIGH BRAKE LAMP FOR VEHICLE WITH BIDIRECTIONAL LIGHT

(71) Applicant: MAGNA MIRRORS (Taicang) AUTOMOTIVE TECHNOLOGY CO., LTD., Jiangsu (CN)

(72) Inventors: Zhenxing MI, Jiangsu (CN); Anmin WU, Jiangsu (CN)

(21) Appl. No.: 15/598,791

(22) Filed: May 18, 2017

(30) Foreign Application Priority Data
Dec. 21, 2016 (CN) 201621406057.2

(51) Int. Cl. F21S 8/10; B60Q 1/44; B60Q 1/00

(52) U.S. Cl. CPC F21S 48/2237; B60Q 1/44; F21Y 2115/10; F21S 48/215; B60Q 1/0011; F21S 48/33

(57) ABSTRACT

The invention relates to a light-guided high brake lamp for vehicle with bidirectional light, comprising a mask and a housing, said mask being fixedly covered on said housing, a containing chamber provided between said mask and said housing, a light guide, at least two light sources and a circuit board assembly are provided in said containing chamber, said at least two light sources being located at two ends of the light guide to form opposing beam illuminating the light guide. Employing the light-guided high brake lamp for vehicle with bidirectional light according to this invention, when the brake pedal of the vehicle is stepped down, the light emitted by the light source forms a uniform strip of light through the refractive stripes on the light guide, so that the driver of vehicle moving behind can easily find the vehicle in front is stopping to prevent the rear-end accident, in order to meet the regulatory requirements about the high brake lamp and to enhance the appearance of the high brake lamp in the vehicle through emitting uniform striped light band.

### FIELD OF THE INVENTION

The invention generally relates to the technical field of automobile parts, especially to the technical field of automobile high brake lamp, in particular to a light-guided high brake lamp for vehicle with bidirectional light.

### BACKGROUND OF THE INVENTION

At present, automobile high brake lamp is generally as direct LED light source type (designed to have the optical structure on the mask) currently on the market, using Fenier lens and metal coating reflective. Because of its relatively simple appearance, which is easy to cause aesthetic fatigue, it is not easy for the driver of the rear vehicle to find that the front vehicle is braking, which is likely to cause rear-end accident.

### SUMMARY OF THE INVENTION

The aim of the invention is to overcome the deficiencies of the above-mentioned prior art, and to provide a light-guided high brake lamp for vehicle with bidirectional light which is capable of satisfying the requirements of the light distribution regulations and making the driver of rear moving vehicle to easily find the vehicle in front is braking.

In order to realize the above aims, this invention comprising:

said high brake lamp for vehicle comprising a mask and a housing, said mask being fixedly covered on said housing, a containing chamber provided between said mask and said housing, a light guide, at least two light sources and a circuit board assembly are provided in said containing chamber, said at least two light sources being located at two ends of the light guide to form opposing beam illuminating the light guide.

Preferably, two light sources are provided and are symmetrical with respect to the center of the light guide.

Preferably, said light guide is an elongated light guide linear or with radians, said light guide being provided with refractive stripes.

More preferably, the light guide has a circular cross section in a longitudinal direction.

More preferably, the light guide is an elongated light guide having a circular cross section in a longitudinal direction.

Preferably, the refractive stripes are successively raised from both ends to the middle of the light guide, and the refractive stripes are symmetrical with respect to the center of the light guide.

Preferably, the outer surface of said mask is provided with a watertight sealing joint strip.

Preferably, the light guide cooperates with the housing through the snap fastener member.

Preferably, the inner of housing is provided with a slot for securing the light source and the circuit board assembly.

Employing the light-guided high brake lamp for vehicle with bidirectional light according to this invention, when the brake pedal of the vehicle is stepped down, the light emitted by the light source forms a uniform strip of light through the refractive stripes on the light guide, so that the driver of vehicle moving behind can easily find the vehicle in front is stopping to prevent the rear-end accident, in order to meet the regulatory requirements about the high brake lamp and to enhance the appearance of the high brake lamp in the vehicle through emitting uniform striped light band.

### BRIEF DESCRIPTION OF THE DRAWINGS

FIG. 1 is a structural schematic diagram showing the overall structure of a light-guided high brake lamp for vehicle with bidirectional light according to the present invention.

FIG. 2 is an exploded view of a light-guided high brake lamp for vehicle with bidirectional light according to the present invention.

FIG. 3 is a cross-sectional view of a light-guided high brake lamp for vehicle with bidirectional light according to the present invention.

ILLUSTRATIONS SIGN
1 mask
2 light guide
21 refractive stripes
3 circuit board assembly
31 first light source
32 second light source
4 housing
5 watertight sealing joint strip

### DETAILED DESCRIPTION OF THE INVENTION

In order to understand the technical content of the present invention clearly, the present invention is further exemplified by reference to the following example.

The light-guided high brake lamp for vehicle with bidirectional light according to the present invention comprising a mask and a housing, said mask being fixedly covered on said housing, a containing chamber provided between said mask and said housing, a light guide, at least two light sources and a circuit board assembly are provided in said containing chamber, said at least two light sources being located at two ends of the light guide to form opposing beam illuminating the light guide.

Wherein two light sources are provided and are symmetrical with respect to the center of the light guide; said light guide is an elongated light guide linear or with radians, said light guide being provided with refractive stripes; the light guide has a circular cross section in a longitudinal direction; the light guide is an elongated light guide having a circular cross section in a longitudinal direction; the refractive stripes are successively raised from both ends to the middle of the light guide, and the refractive stripes are symmetrical with respect to the center of the light guide; the outer surface of said mask is provided with a watertight sealing joint strip; the light guide cooperates with the housing through the snap fastener member; the inner of housing is provided with a slot for securing the light source and the circuit board assembly.

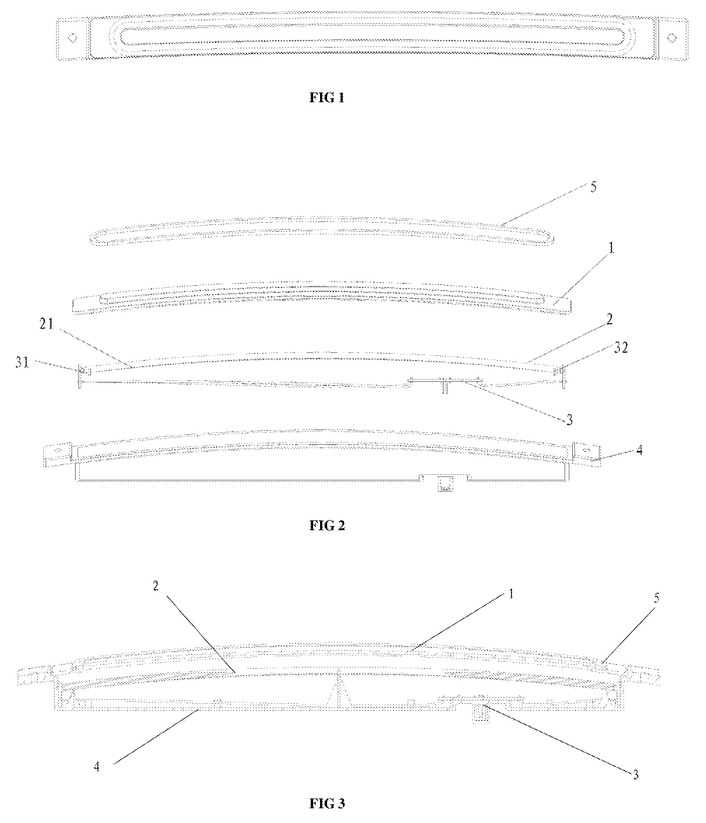

As shown in FIG. 1, the present invention provides an overall plan view of a light-guided high brake lamp for vehicle with bidirectional light, and as shown in FIG. 2, the present invention provides a light-guided high brake lamp for vehicle with bidirectional light including a mask 1, a light guide 2, a circuit board assembly 3, a housing 4, mask 1 being fixedly covered on said housing 4, a containing chamber provided between mask 1 and housing 4, said containing chamber being provided with a light guide 2 and a circuit board assembly 3. The first light source 31 and the second light source 32 emitting toward the circular light guide 2 are respectively located at two ends of the light guide 2, and emit simultaneously the opposite light to the circular light guide 2 through the refractive stripes 21 on the circular light guide to form a uniform strip light band.

In one embodiment according to the present invention, two light sources are provided on two sides of the light guide 2 and are symmetrical with respect to the center of the light guide 2.

In one embodiment according to the present invention, the refractive stripes 21 are successively raised from both ends to the middle of the light guide, and the refractive stripes are symmetrical with respect to the center of the light guide.

In one embodiment according to the present invention, mask 1 and housing 4 may be connected by welding, for example, by ultrasonic or vibration friction welding, or by other means such as cementing, screw connection or engagement with a concavo-convex structure.

In one embodiment provided by the invention, the light source and the circuit board assembly 3 are assembled to the housing 4 through a slot, by buckle or riveting.

In one embodiment provided by the invention, the light guide 2 and the housing 4 are assembled by snap fastener member.

In one embodiment provided by the invention, the mask 1 is affixed with a watertight sealing joint strip 5.

Employing the light-guided high brake lamp for vehicle with bidirectional light according to this invention, when the brake pedal of the vehicle is stepped down, the light emitted by the light source forms a uniform strip of light through the refractive stripes on the light guide, so that the driver of vehicle moving behind can easily find the vehicle in front is stopping to prevent the rear-end accident, in order to meet the regulatory requirements about the high brake lamp and to enhance the appearance of the high brake lamp in the vehicle through emitting uniform striped light band.

In the present specification, the present invention has been described according to the particular embodiments. But it is obvious that these embodiments can be modified or changed without departure from the spirit and scope of the present invention. Therefore, the specification described above is exemplary only and not intended to be limiting.

I claim:

1. A light-guided high brake lamp for vehicle with bidirectional light comprising a mask and a housing, said mask being fixedly covered on said housing, a containing chamber provided between said mask and said housing, a light guide, at least two light sources and a circuit board assembly are provided in said containing chamber, said at least two light sources being located at two ends of the light guide to form opposing beam illuminating the light guide.

2. A light-guided high brake lamp for vehicle with bidirectional light as claimed in claim 1, wherein two light sources are provided and are symmetrical with respect to the center of the light guide.

3. A light-guided high brake lamp for vehicle with bidirectional light as claimed in claim 1, wherein said light guide is an elongated light guide linear or with radians, said light guide being provided with refractive stripes.

4. A light-guided high brake lamp for vehicle with bidirectional light as claimed in claim 3, the light guide has a circular cross section in a longitudinal direction.

5. A light-guided high brake lamp for vehicle with bidirectional light as claimed in claim 3, wherein the refractive stripes are successively raised from both ends to the middle of the light guide, and the refractive stripes are symmetrical with respect to the center of the light guide.

6. A light-guided high brake lamp for vehicle with bidirectional light as claimed in claim 1, wherein the outer surface of said mask is provided with a watertight sealing strip.

7. A light-guided high brake lamp for vehicle with bidirectional light as claimed in claim 1, wherein the light guide cooperates with the housing through the snap fastener.

8. A light-guided high brake lamp for vehicle with bidirectional light as claimed in claim 1, wherein the inner of housing is provided with a slot for securing the light source and the circuit board assembly.
